(19) United States
(12) Patent Application Publication
(10) Pub. No.: US 2025/0341721 A1
(43) Pub. Date: Nov. 6, 2025

(54) PROJECTION SYSTEM AND HEAD-MOUNTED DISPLAY

(71) Applicant: Goertek Optical Technology Co., Ltd., Weifang, Shandong (CN)

(72) Inventors: Yun Zhao, Shandong (CN); Gongtao Lu, Shandong (CN); Yi Rao, Shandong (CN)

(73) Assignee: Goertek Optical Technology Co., Ltd., Weifang, Shandong (CN)

(21) Appl. No.: 18/870,782

(22) PCT Filed: Jun. 20, 2022
(86) PCT No.: PCT/CN2022/099790

§ 371 Date: Dec. 2, 2024

(30) Foreign Application Priority Data
May 30, 2022 (CN) 202210604142.3

(51) Int. Cl. G02B 27/01; G03B 21/00; G03B 21/20

(52) U.S. Cl. CPC G02B 27/0172; G03B 21/2053; G03B 21/2066; G03B 21/2073; G03B 21/208; G03B 21/006

(57) ABSTRACT

The disclosure discloses a projecting system. The projecting system includes a light source assembly, a polarization element, a light beam adjusting module, and a reflection component; the light beam adjusting module has an optical axis, and the light source assembly is located on a first side of the optical axis; light emitted by the light source assembly is transmitted through the polarization element to the light beam adjusting module, and at least central light of the light is incident from the first side of the optical axis into the light beam adjusting module and is shaped; light incident into the light beam adjusting module is reflected back to the light beam adjusting module by the reflection component, and at least central light of reflected light is emergent from a second side of the optical axis to form an image, and then is reflected by the polarization element and output.

### CROSS-REFERENCE TO RELATED APPLICATIONS

The present disclosure is a National Stage of International Application No. PCT/CN2022/099790, filed on Jun. 20, 2022, which claims priority to a Chinese patent application No. 202210604142.3 filed with the CNIPA on May 30, 2022, both of which are hereby incorporated by reference in their entireties.

### TECHNICAL FIELD

The present disclosure relates to the technical field of optical devices, and particularly to a projecting system and a head mounted device.

### BACKGROUND

With the advancement of imaging technology, demands for immersive experiences are increasingly growing. In recent years, the development of VR/AR technologies has gradually met people's pursuit of visual experiences. A head-mounted device can free people's hands, reduce dependence on screen, and simultaneously create better visual effects.

The architecture of a traditional LCOS AR optical machine includes illumination and imaging parts. The illumination part contains collimating and shaping components, which collimates and shapes the light emitted from the light source to match the light-spot with a LCOS chip. The imaging part functions to transmit the image on the LCOS chip into the waveguide sheet. In traditional LCOS AR optical machines, a separate shaping component is needed to shape the light, a separate imaging component is required for final imaging. This directly leads to the inability to further reduce the volume of the projection system.

### SUMMARY

An objective of the present disclosure is to provide new technical solutions for a projecting system and a head mounted device.

According to a first aspect of embodiments of the present disclosure, a projecting system is provided. The projecting system includes:
a light source assembly, a polarization element, a light beam adjusting module, and a reflection component;
the light beam adjusting module has an optical axis, and the light source assembly is located on a first side of the optical axis;
light emitted by the light source assembly is transmitted through the polarization element to the light beam adjusting module, and at least central light of the light is incident from the first side of the optical axis into the light beam adjusting module and is shaped;
light incident into the light beam adjusting module is reflected back to the light beam adjusting module by the reflection component, and at least central light of reflected light is emergent from a second side of the optical axis to form an image, and then is reflected by the polarization element and output.

Optionally, the light beam adjusting module includes a lens assembly, which shapes light incident into the light beam adjusting module and images light reflected to the light beam adjusting module.

Optionally, the light beam adjusting module further includes a first phase retardation plate, which is located between the polarization element and the reflection component.

Optionally, the light beam adjusting module further includes a brightness regulator, which is located between the polarization element and the reflection component.

Optionally, the light beam adjusting module includes a lens assembly, a first phase retardation plate, and a brightness regulator, which are provided between the polarization element and the reflection component.

Optionally, the brightness regulator includes a second phase retardation plate and a third phase retardation plate, the second phase retardation plate is fixedly provided, and the third phase retardation plate is movably provided:
the second phase retardation plate has a first fast axis, the third phase retardation plate has a second fast axis, and the third phase retardation plate is configured to rotate relative to the second phase retardation plate to adjust an angle between the first fast axis and the second fast axis.

Optionally, the light source assembly includes a light source and a reflector bowl, and when the light emitted by the light source is reflected by the reflector bowl, the light travels parallel to the optical axis and then is transmitted through the polarization element to the light beam adjusting module.

Optionally, the projecting system further includes an optical waveguide sheet, which includes a coupling-in area and a coupling-out area: the light reflected by the polarization element is transmitted to the coupling-in area, then is transmitted through the optical waveguide sheet to the coupling-out area, and is finally output from the coupling-out area.

According to a second aspect of embodiments of the present disclosure, a head mounted device is provided. The head mounted device includes the projecting system according to the first aspect.

In the embodiments of the present disclosure, a projecting system is provided, which achieves the objective of reducing the volume of the projection system.

Other features and advantages of the present disclosure will become apparent from the following detailed description of exemplary embodiments of the present disclosure with reference to the accompanying drawings.

### BRIEF DESCRIPTION OF THE DRAWINGS

In order to clearly illustrate embodiments of the present disclosure or technical solutions in the prior art, accompanying drawings that need to be used in description of the embodiments or the prior art will be briefly introduced as follows. Obviously, drawings in following description are only the embodiments of the present disclosure. For those skilled in the art, other drawings can also be obtained according to the disclosed drawings without creative efforts.

FIG. 1 shows a schematic structural diagram of a projection system of the present disclosure.

FIG. 2 is an optical path structural diagram of the projection system of the present disclosure.

FIG. 3 shows a schematic structural diagram of the light source assembly.

### DESCRIPTION OF REFERENCE SIGNS

1. light source assembly; 11. light source; 12. reflector bowl; 2. polarization element; 3. light beam adjusting module; 31. first phase retardation plate; 32. lens assembly; 321. first lens; 322. second lens; 323. third lens; 324. fourth lens; 33. brightness regulator; 331. second phase retardation plate; 332. third phase retardation plate; 4. reflection component; 5. optical waveguide sheet; 51. coupling-in area; 52. coupling-out area; 6. human eye.

### DETAILED DESCRIPTION

Various exemplary embodiments of the present disclosure will now be described in detail with reference to the accompanying drawings. It is to be noted that unless otherwise specified, the relative arrangements, numerical expressions and values of components and steps illustrated in the embodiments do not limit the scope of the present disclosure.

The description of at least one exemplary embodiment is for illustrative purpose only and in no way implies any restriction on the present disclosure, its application, or use.

Techniques, methods and devices known to those skilled in the prior art may not be discussed in detail; however, such techniques, methods and devices shall be regarded as part of the description where appropriate.

In all the examples illustrated and discussed herein, any specific value shall be interpreted as illustrative rather than restrictive. Therefore, other examples of the exemplary embodiments may have different values.

It is to be noted that similar reference numbers and alphabetical letters represent similar items in the accompanying drawings. Once an item is defined in one drawing, further reference to it may be omitted in subsequent drawings.

The architecture of the existing AR optical machine includes illumination and imaging parts, wherein the illumination part includes a shaping component which shapes the light emitted by a light source, and the imaging part includes an imaging component which realizes imaging of an image. Therefore, in the architecture of existing AR optical machines, a separate shaping component and a separate imaging component are required to correspondingly process the light. In this way, the volume of the architecture of the existing AR optical machine cannot be further reduced.

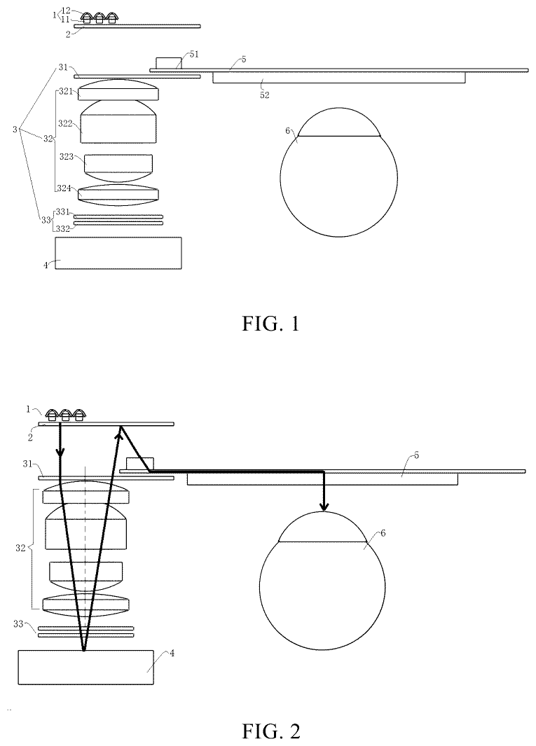

In view of the above technical problems, the present disclosure provides a projection system. Referring to FIGS. 1 to 3, the projection system includes a light source assembly 1, a polarization element 2, a light beam adjusting module 3, and a reflection component 4. The light beam adjusting module 3 has an optical axis, and the light source assembly 1 is located on a first side of the optical axis. Light emitted by the light source assembly 1 is transmitted through the polarization element 2 to the light beam adjusting module 3, and at least central light of the light is incident from the first side of the optical axis into the light beam adjusting module 3, and is shaped. Light incident into the light beam adjusting module 3 is reflected back to the light beam adjusting module 3 by the reflection component 4, and at least central light of reflected light is emergent from a second side of the optical axis to form an image, and then is reflected by the polarization element 2 and output.

In the embodiment, 1 shows a schematic structural diagram of the projection system. 2 shows a light path diagram of the projection system. Here, the bold black line in 2 represents the transmission optical path of the light, and the dashed line in 2 represents the optical axis of the light beam adjusting module 3.

Referring to FIGS. 1 and 2, the light emitted by the light source assembly 1 is transmitted through the polarization element 2 to the light beam adjusting module 3, and the light beam adjusting module 3 shapes the incident light: the shaped light is reflected by the reflection component 4, and the reflected light carries image information, such that the shaped light returns to the light beam adjusting module 3 again for transmission and is emergent therefrom. Therefore, in the embodiment, there is no separate shaping component provided in the light source assembly 1. Instead, the light beam adjusting modules 3 serves as both the component for shaping the light and the component for imaging a picture (i.e., the light beam adjusting module 3 has both the function of shaping the light and the function of imaging a picture), thereby reducing the volume of the projection system.

Specifically, the present embodiment limits the arranging position of the light source assembly 1, i.e., the light source assembly 1 is eccentrically provided relative to the optical axis of the light beam adjusting module 3, so that the light emitted by the light source assembly 1 does not travel straight in and out, but rather at least the central light of the incident light is incident into the first side of the light beam adjusting module 3, and at least the central light of the reflected light is emergent from the second side of the light beam adjusting module 3, wherein the first side and the second side are located on different sides of the optical axis.

In the prior art, the incident light enters the light beam adjusting module 3 along the direction of the optical axis. In the case that the incident light enters the light beam adjusting module 3 along the direction of the optical axis, the incident light is incident along the direction of the optical axis, and after being reflected by the reflection component 4, the reflected light is emergent also along the direction of the optical axis. The incident light and reflected light are superimposed, and thus the light beam adjusting module 3 can only function to image a picture but cannot shape the light.

The embodiment of the present disclosure arranges the light source assembly 1 eccentrically relative to the optical axis of the light beam adjusting module 3, such that at least the central lights of the incident light and the reflected light are transmitted without overlapping. In this way, the incident light is transmitted off-axis relative to the optical axis, such that the incident light may shape the light by means of the first side of the light beam adjusting module 3, while the reflected light is transmitted through the second side of the light beam adjusting module 3, such that the second side of the light beam adjusting module 3 may image the light carrying picture information.

Therefore, the embodiment of the present disclosure limits the arranging position of the light source assembly 1, so that the shaping of the light and the imaging of the light share the same set of light beam adjusting modules 3, thereby avoiding the need to provide a separate shaping component in the light source assembly 1 to shape the light beam, and thus reducing the volume of the projection system.

In the present embodiment, the projection system includes a polarization element 2, which is provided on the light transmission path. For example, the polarization element 2 may be a polarizing reflector. The polarizing reflector may selectively reflect or transmit light, for instance, the polarizing reflector reflects S light and transmits P light. Specifically, the light emitted by the light source assembly 1 is natural light, containing 50% P light and 50% S light. The polarizing reflector may reflect the S light in the light emitted by the light source assembly 1 and only retain the P light, such that the P light is transmitted through the polarizing reflector, undergoes shaping processing in the light beam adjusting module 3, and continues to propagate within the projection system. Moreover, the polarizing reflector is provided between the light source assembly 1 and the light beam adjusting module 3, the light emergent from the second side of the light beam adjusting module 3 is reflected by the polarizing reflector, the reflected light is then output, and the output light is received by the human eye 6.

In the present embodiment, the reflection component 4 reflects the light. For example, the reflection component 4 may be a light valve component. For instance, the light valve component belongs to a polarizing beamsplitter component. For example, the light valve component may include but is not limited to an LCOS display, and can also be an LCD display.

It should be noted that the optical axis is the central axis of the light beam adjusting module 3.

In an optional embodiment, as shown in 2, there is an angle between the light incident from the first side of the optical axis and the optical axis itself, with the angle ranging from 10° to 15°.

In the present embodiment, the light is incident into the first side of the optical axis, meaning that the light is incident into the first side of the light beam adjusting module 3. There is an angle between the light incident from the first side of the light beam adjusting module 3 and the optical axis of the light beam adjusting module 3, with the angle ranging from 10° to 15°.

Specifically, the light source assembly 1 is eccentrically provided relative to the optical axis, and therefore, the light emitted by the light source assembly 1 will not be incident perpendicularly into the reflection component 4 (LCOS chip) but rather at a certain angle, which is approximately 10° to 15°. The present embodiment limits the angle between the light incident into the first side of the light beam adjusting module 3 and the optical axis of the light beam adjusting module 3, such that the first side of the light beam adjusting module 3 may shape the incident light. If the angle is too large or too small, it would affect the shaping effect of the first side of the light beam adjusting module 3 on the incident light, meaning that if the angle is too large or too small, the incident light cannot be shaped according to the structure (specifically referring to the lens structure) of the first side of the light beam adjusting module 3.

Specifically, the light incident into the reflection component 4 (LCOS chip) is P light (since the light emitted by the light source assembly 1 passes through the polarization element 2 for the first time and transmits the P light), and after modulation by the reflection component 4 (LCOS chip), the light producing the picture is the S light, and the polarization element 2 outputs the S light produced by the reflection component 4 (LCOS chip).

The light reflected by the reflection component 4 (LCOS chip) also has the same angle. After being imaged by the light beam adjusting module 3, the reflected light will reach the polarization element 2. If the angle between the light incident into the first side of the light beam adjusting module 3 and the optical axis of the light beam adjusting module 3 is too large or too small, the angle between the reflected light and the optical axis will also be too small or too large. If the angle is too small or too large, the reflected light cannot accurately reach the polarization element 2.

In an embodiment, as shown in FIGS. 1 and 2, the light beam adjusting module 3 includes a lens assembly 32, which shapes light incident into the light beam adjusting module 3 and images light reflected to the light beam adjusting module 3.

In the present embodiment, the light beam adjusting module 3 includes a lens assembly 32 (also known as a lens module), which has two functions: one function is to shape the light emitted by the light source assembly 1, to shape the circular light-spot emitted by the light source assembly 1 into a rectangular light-spot to adapt to the effective area of the reflection component 4 (LCOS chip): the other function is to complete the imaging effect, ensuring that the image produced on the reflection component 4 (LCOS chip) is clearly transmitted.

Specifically, the light source assembly 1 is eccentrically provided relative to the optical axis of the lens assembly 32, the light emitted by the light source assembly 1 is transmitted through the polarization element 2 to be incident into the first side of the lens assembly 32, and the first side of the lens assembly 32 shapes the light emitted by the light source assembly 1: the shaped light is reflected by the reflection component 4, and the reflected light is transmitted through the second side of the lens assembly 32, such that the image produced on the reflection component 4 (LCOS chip) is clearly transmitted.

In an optional embodiment, as shown in FIGS. 1 and 2, the lens assembly 32 includes a first lens 321, a second lens 322, a third lens 323, and a fourth lens 324 arranged sequentially along the optical axis, with the fourth lens 324 provided proximate to the reflection component 4. The present embodiment shapes the light and clearly transmits the image produced on the reflection component 4 (LCOS chip) by providing four lenses, thereby reducing the volume of the projection system.

In an optional embodiment, along the direction of the optical axis, the first surface of the first lens 321 is convex, the second surface of the first lens 321 is flat, and the focal power of the first lens 321 is positive: the first surface of the second lens 322 is convex, the second surface of the second lens 322 is flat, and the focal power of the second lens 322 is positive: the first surface of the third lens 323 is flat, the second surface of the third lens 323 is convex, and the focal power of the third lens 323 is positive: the first surface of the fourth lens 324 is convex, the second surface of the fourth lens 324 is convex, and the focal power of the fourth lens 324 is positive. Here, the second surfaces of the above lenses are all surfaces closer to the reflection component 4.

In the present embodiment, the first lens 321, the second lens 322, and the third lens 323 are convex cylindrical lens. Specifically, the first lens 321, the second lens 322, and the third lens 323 are shaped convex cylindrical lens. The fourth lens 324 is a biconvex lens, mainly used for converging the shaped light, and during the imaging process, the biconvex lens transmits the image together with other lenses.

In an optional embodiment, the focal length range of the first lens 321 is 7 mm to 10 mm; the focal length range of the second lens 322 is −9 mm to −6 mm; the focal length range of the third lens 323 is 3 mm to 5 mm; the focal length range of the fourth lens 324 is 6 mm to 8 mm.

In the present embodiment, the focal length ranges of the first lens 321, the second lens 322, the third lens 323, and the fourth lens 324 are defined such that the light incident into the lens assembly 32 forms uniformized light, thereby shaping the incident light; moreover, the focal length ranges of the first lens 321, the second lens 322, the third lens 323, and the fourth lens 324 are defined such that the image produced on the reflection component 4 (LCOS chip) is clearly transmitted.

In a specific embodiment, the lens parameters of the first lens 321, the second lens 322, the third lens 323 and the fourth lens 324 may refer to Tables 1 to 3.

TABLE 1

| | radius of | thickness | refractive | Abbe |
|---|---|---|---|---|
| No. | curvature (mm) | (mm) | index Nd | number Vd |
| 321 | 4.99 | 0.9 | 2.0 | 25.4 |
| | 11.64 | 0.1 | | |
| 322 | 2.57 | 1.7 | 1.52 | 64.2 |
| | 1.57 | 1.97 | | |
| 323 | −1.85 | 0.8 | 1.49 | 70.4 |
| | −3.44 | 1.66 | | |
| 324 | 8.46 | 1.09 | 2.0 | 25.4 |
| | −7.14 | 1.56 | | |

TABLE 2

| | radius of | thickness | refractive | Abbe |
|---|---|---|---|---|
| No. | curvature (mm) | (mm) | index Nd | number Vd |
| 321 | 5.05 | 0.68 | 2.0 | 25.4 |
| | 12.2 | 0.04 | | |
| 322 | 2.47 | 1.66 | 1.52 | 64.2 |
| | 1.54 | 2.15 | | |
| 323 | −1.96 | 1.07 | 1.49 | 70.4 |
| | −4.04 | 0.05 | | |
| 324 | 9 | 1.03 | 2.0 | 25.4 |
| | −7.42 | 1.55 | | |

TABLE 3

| | radius of | thickness | refractive | Abbe |
|---|---|---|---|---|
| No. | curvature (mm) | (mm) | index Nd | number Vd |
| 321 | 4.87 | 0.89 | 2.0 | 25.4 |
| | 11.1 | 0.06 | | |
| 322 | 2.51 | 1.61 | 1.52 | 64.2 |
| | 1.56 | 1.99 | | |
| 323 | −1.84 | 0.77 | 1.49 | 70.4 |
| | −3.4 | 0.23 | | |
| 324 | 8.8 | 1.09 | 2.0 | 25.4 |
| | −7.06 | 1.57 | | |

In the present embodiment, the surface structures of the first lens 321, the second lens 322, the third lens 323, and the fourth lens 324 are defined such that the light incident into the lens assembly 32 form uniformized light, so as to shape the incident light; and the surface structures of the first lens 321, the second lens 322, the third lens 323, and the fourth lens 324 are defined such that the image produced on the reflection component 4 (LCOS chip) is clearly transmitted.

In an embodiment, referring to FIGS. 1 and 2, the light beam adjusting module 3 further includes a first phase retardation plate 31, which is located between the polarization element 2 and the reflection component 4.

In the present embodiment, the first phase retardation plate 31, which can be a quarter-wave plate, is provided between the polarization element 2 and the reflection component 4. The purpose of providing the first phase retardation plate 31 between the polarization element 2 and the reflection component 4 is to improve the contrast of the projection system.

Specifically, the reflection component 4 (LCOS chip) serves as an image source, and may convert the incident P light into the S light by modulating the phase. However, due to differences in the manufacturing processes of different reflection components 4 (LCOS chips), not all P light can be converted into the S light, which leads to an increase in the dark field brightness of the picture, thereby causing a decrease in contrast.

To enhance the contrast of the projection system, the first phase retardation plate 31 is provided between the polarization element 2 and the reflection component 4. By finely adjusting the angle between the fast axis (the direction of the light vector with slower propagation speed in the phase retardation plate is referred to as the slow axis: the direction of the light vector with faster propagation speed in the phase retardation plate is referred to as the fast axis) of the first phase retardation plate 31 and the P light, it is possible to modulate the P light in advance and to ensure that the modulated P light, after being reflected by the reflection component 4 (LCOS chip), turns into 100% S light, thereby improving the contrast of the optical machine.

In a specific embodiment, the light beam adjusting module 3 includes a lens assembly 32 and a first phase retardation plate 31, wherein the first phase retardation plate 31 may be located between the lens assembly 32 and the polarization element 2, or may be located between the lens assembly 32 and the reflection component 4. The present embodiment does not particularly limit the first phase retardation plate 31 and the lens assembly 32, as long as both are arranged along the optical axis of the light beam adjusting module 3 (i.e., the optical axis of the lens assembly 32).

In an embodiment, referring to FIGS. 1 and 2, the light beam adjusting module 3 further includes a brightness regulator 33, which is located between the polarization element 2 and the reflection component 4.

In the present embodiment, the light beam adjusting module 3 further includes a brightness regulator 33. The projection system will detect the ambient light brightness in real-time, and when it is in a bright outdoor environment, the brightness regulator 33 adjusts the brightness to maximize the brightness perceived by the eye. When the projection system is in an indoor or night dark environment, the brightness regulator 33 adjusts the brightness to appropriately reduce the brightness perceived by the eye, thereby enhancing the comfort of the projection system.

In a specific embodiment, the light beam adjusting module 3 includes a lens assembly 32 and a brightness regulator 33, wherein the brightness regulator 33 may be located between the lens assembly 32 and the polarization element 2 or between the lens assembly 32 and the reflection component 4. The present embodiment does not particularly limit the brightness regulator 33 and the lens assembly 32, as long as both are arranged along the optical axis of the light beam adjusting module 3 (i.e., the optical axis of the lens assembly 32).

In an embodiment, the light beam adjusting module 3 includes a lens assembly 32, a first phase retardation plate 31, and a brightness regulator 33, which are arranged along the optical axis between the polarization element 2 and the reflection component 4.

In the present embodiment, the light beam adjusting module 3 includes a first phase retardation plate 31, a brightness regulator 33, and a lens assembly 32, which are arranged along the optical axis of the lens assembly 32. The order of positions of these three components can be interchanged and is not limited to the arrangement shown in FIGS. 1 and 2.

In an embodiment, referring to FIGS. 1 and 2, the brightness regulator 33 includes a second phase retardation plate 331 and a third phase retardation plate 332, the second phase retardation plate 331 is fixedly provided, and the third phase retardation plate 332 is movably provided:
the second phase retardation plate 331 has a first fast axis, the third phase retardation plate 332 has a second fast axis, and the third phase retardation plate 332 is configured to rotate relative to the second phase retardation plate 331 to adjust an angle between the first fast axis and the second fast axis.

In the present embodiment, the brightness regulator 33 consists of two circular phase retardation plates, each having a fast axis. Of the two phase retardation plates, one is fixedly provided, and the other may be rotated around its center. When the other phase retardation plate is rotated so that the fast axes of the two phase retardation plates are coincided, all light may pass through. When the other phase retardation plate is rotated so that the fast axes of the two phase retardation plates are perpendicular at 90°, no light can pass through.

Therefore, the brightness of the light is adjusted by the angle between the fast axes of the two phase retardation plates. Specifically, the projection system detects the ambient light brightness in real-time. When in a bright outdoor environment, the fast axes of the two phase retardation plates are coincided to achieve the highest brightness perceived by the eye: when in an indoor or night dark environment, one of the phase retardation plates is rotated around its center, such that the fast axes of the two phase retardation plates have a certain angle less than 90°, thereby appropriately reducing the brightness perceived by the eye and enhancing the comfort of the whole AR device.

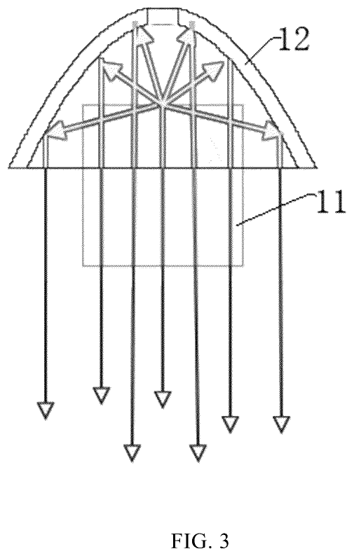

In an embodiment, referring to FIGS. 1 and 3, the light source assembly 1 includes a light source 11 and a reflector bowl 12, and when the light emitted by the light source 11 is reflected by the reflector bowl 12, the light travels parallel to the optical axis and then is transmitted through the polarization element 2 to the light beam adjusting module 3.

Specifically, the light source 11 includes three light sources 11, namely the first light source 11, the second light source 11 and the third light source 11, which are all LED light sources and emit red, green, and blue light, respectively. Here, the light source 11 emits light at a wide angle, and thus a collimating device is needed to narrow the angle of the light. In the present embodiment, a CPC (compound parabolic concentrator) reflector bowl 12 is provided above the light source 11.

When the reflector bowl 12 is provided on the light source 11, the light will strike the inner wall of the reflector bowl 12 and, after being reflected by the reflector bowl 12, propagates vertically downwards, thereby achieving the effect of collimating the light.

In an embodiment, the projecting system further comprises an optical waveguide sheet 5, which comprises a coupling-in area 51 and a coupling-out area 52: the light reflected by the polarization element 2 is transmitted to the coupling-in area 51, then is transmitted through the optical waveguide sheet 5 to the coupling-out area 52, and is finally output from the coupling-out area 52.

In the present embodiment, the light reflected by the polarization element 2 is not directly transmitted to the human eye 6. Instead, the optical waveguide sheet 5 is provided in the transmission path of the light, and the light reflected by the polarization element 2 is transmitted to the human eye 6 after being output by the optical waveguide sheet 5.

According to the second aspect of the embodiment of the present disclosure, a head mounted device is provided. The head mounted device includes the projection system as described in the first aspect. For example, the head mounted device is an AR head mounted device. For example, the head mounted device is an AR optical machine.

The above embodiments focus on the differences between the various embodiments, and the different optimization features between the various embodiments, as long as they do not contradict each other, may be combined to form a better embodiment, which will not be repeated herein taking into account the brevity of the text.

Although some specific embodiments of the present disclosure have been described in detail through examples, those skilled in the art should understand that the above examples are for illustration only and are not intended to limit the scope of the present disclosure. Those skilled in the art should understand that the above embodiments can be modified without departing from the scope and spirit of the present disclosure. The scope of the present disclosure is defined by the accompanying claims.

1. A projecting system, comprising: a light source assembly, a polarization element, a light beam adjusting module, and a reflection component: wherein,
the light beam adjusting module has an optical axis, and the light source assembly is located on a first side of the optical axis;
the light source assembly is configured to emit light to be transmitted through the polarization element to the light beam adjusting module such that at least a central portion of emitted light is incident from the first side of the optical axis into the light beam adjusting module for being shaped;
the reflection component is configured to reflect back light incident into the light beam adjusting module to the light beam adjusting module such that at least a central portion of reflected light is emergent from a second side of the optical axis to form an image, and then is reflected by the polarization element and output.

2. The projecting system according to claim 1, wherein the light beam adjusting module comprises a lens assembly, configured to shapes light incident into the light beam adjusting module and images light reflected to the light beam adjusting module.

3. The projecting system according to claim 1, wherein the light beam adjusting module further comprises a first phase retardation plate, located between the polarization element and the reflection component.

4. The projecting system according to claim 1, wherein the light beam adjusting module further comprises a brightness regulator, located between the polarization element and the reflection component.

5. The projecting system according to claim 1, wherein the light beam adjusting module comprises a lens assembly, a first phase retardation plate, and a brightness regulator, which are provided between the polarization element and the reflection component.

6. The projecting system according to claim 5, wherein the brightness regulator comprises a fixed second phase retardation plate and a movable third phase retardation plate;
the second phase retardation plate has a first fast axis, the third phase retardation plate has a second fast axis, and the third phase retardation plate is configured to rotate relative to the second phase retardation plate to adjust an angle between the first fast axis and the second fast axis.

7. The projecting system according to claim 1, wherein the light source assembly comprises a light source and a reflector bowl, and the reflector bowl is configured to reflect the emitted light, that the reflected light travels parallel to the optical axis and then is transmitted through the polarization element to the light beam adjusting module.

8. The projecting system according to claim 1, further comprises an optical waveguide sheet, which comprises a coupling-in area and a coupling-out area; such that the light reflected by the polarization element is transmitted to the coupling-in area, then is transmitted through the optical waveguide sheet to the coupling-out area, and is finally output from the coupling-out area.

9. A head mounted device, comprising a projecting system according to claim 1.
